(19) United States
(12) Patent Application Publication
(10) Pub. No.: US 2026/0331688 A1
(43) Pub. Date: Oct. 22, 2026

(54) APPARATUS AND METHOD FOR CONTROLLING VENTILATION AND ENERGY STORAGE SYSTEM INCLUDING THE SAME

(71) Applicant: LG ENERGY SOLUTION, LTD., Seoul (KR)

(72) Inventors: Hyun-Min LEE, Daejeon (KR); Min-Seok KANG, Daejeon (KR); Min-Chul KIM, Daejeon (KR); Yong-Tae LEE, Daejeon (KR); Ji-Won LEE, Daejeon (KR)

(73) Assignee: LG ENERGY SOLUTION, LTD., Seoul (KR)

(21) Appl. No.: 19/468,764

(22) Filed: Feb. 3, 2026

(30) Foreign Application Priority Data
Feb. 4, 2025 (KR) 10-2025-0014089

(51) Int. Cl. H01M 50/317; H01M 10/42; H01M 10/48

(52) U.S. Cl. CPC H01M 50/317; H01M 10/4257; H01M 10/486

(57) ABSTRACT

A ventilation control apparatus according to an embodiment of the present disclosure is installed in a battery container including one or more batteries. The ventilation control apparatus includes: a smoke detection unit configured to detect smoke inside the battery container and to output a sensing signal when the smoke is detected; and a control unit configured to, upon receiving the sensing signal, control an operating state of a ventilation unit installed in the battery container to a turned-on state, and to output, to an external device, a ventilation operation signal indicating that the operating state of the ventilation unit has been controlled to the turned-on state.

### CROSS-REFERENCE TO RELATED APPLICATIONS

This application is based on and claims priority from Korean Patent Application No. 10-2025-0014089 filed on Feb. 4, 2025, with the Korean Intellectual Property Office, the disclosure of which is incorporated herein in its entirety by reference.

### TECHNICAL FIELD

The present disclosure relates to a ventilation control apparatus and method for controlling ventilation of a battery container, and to an energy storage system including a battery container and a control container.

### BACKGROUND

Recently, as demand for portable electronic products such as notebook computers, video cameras, and mobile phones has dramatically increased, and as the development of electric vehicles, energy storage batteries, robots, and satellites is actively pursued, research on high-performance batteries capable of repeated charging and discharging is being actively conducted.

Currently, commercialized batteries include, for example, nickel-cadmium batteries, nickel-metal hydride batteries, nickel-zinc batteries, and lithium batteries. Among these, lithium batteries have attracted significant attention due to advantages such as substantially reduced memory effect compared to nickel-based batteries, allowing free charging and discharging, a very low self-discharge rate, and high energy density.

An energy storage system using such batteries may store large-scale electric power and provide the stored electric power to a plurality of load facilities. For example, the energy storage system is used in the form of an industrial, building, or residential energy management system, and is used as a regular power grid and/or an emergency power grid by supplying the stored electric power to load facilities at respective usage sites.

Such an energy storage system has a risk of fire due to the vulnerability of the batteries, and technical challenges for early detection of a fire and prompt response thereto still remain.

### SUMMARY

The present disclosure provides a ventilation control method, a ventilation control apparatus, and an energy storage system including the same, which are capable of monitoring a fire within an energy storage system and suppressing the fire at an early stage.

Other objects and advantages of the present disclosure may be understood from the following description and will become more apparent from the embodiments of the present disclosure. In addition, it will be readily understood that the objects and advantages of the present disclosure may be realized by the means and combinations thereof as set forth in the appended claims.

A ventilation control apparatus according to an aspect of the present disclosure is installed in a battery container including one or more batteries, and may include: a smoke detection unit that detects smoke inside the battery container and outputs a sensing signal when the smoke is detected; and a control unit that, upon receiving the sensing signal, controls an operating state of a ventilation unit installed in the battery container to a turned-on state, and outputs, to an external device, a ventilation operation signal indicating that the operating state of the ventilation unit has been controlled to the turned-on state.

The control unit may be configured to control the operating state of the ventilation unit to a turned-off state upon receiving a ventilation termination signal for the battery container from the external device after outputting the ventilation operation signal to the external device.

The control unit may include: a first control unit that, upon receiving the sensing signal from the smoke detection unit, outputs the ventilation operation signal to a second control unit and the external device; and the second control unit that, upon receiving the ventilation operation signal from the first control unit, controls the operating state of the ventilation unit to the turned-on state.

The first control unit may be configured to control an operating state of a fan included in the ventilation unit to a turned-off state upon receiving a first ventilation termination signal from the external device.

The second control unit may be configured to control an operating state of an opening/closing unit included in the ventilation unit to a closed state upon receiving a second ventilation termination signal from the external device.

The first control unit may be configured to control the operating state of the ventilation unit to a turned-off state upon receiving the first ventilation termination signal from the external device.

The first control unit may be configured to control the operating state of the ventilation unit to the turned-off state by controlling an operating state of a relay electrically connected to the ventilation unit to the turned-off state.

An energy storage system according to another aspect of the present disclosure may include: the battery container including the ventilation control apparatus according to an aspect of the present disclosure; and a control container.

The control container may include a main control unit that determines occurrence of a fire in the battery container upon receiving the ventilation operation signal from the control unit.

The main control unit may be configured to determine the occurrence of a fire based on at least one of a temperature of the battery container, a voltage of the one or more batteries, and a temperature of the one or more batteries, which are measured for a predetermined period of time from a time point at which the ventilation operation signal is received.

The main control unit may include: a first main control unit that receives the ventilation operation signal from the control unit; and a second main control unit that determines the occurrence of a fire upon receiving the ventilation operation signal from the first main control unit.

The second main control unit may be configured to output a fire non-occurrence signal to the first main control unit upon determining that a fire has not occurred in the battery container.

The first main control unit may be configured to output a ventilation termination signal to the control unit upon receiving the fire non-occurrence signal from the second main control unit.

A ventilation control method according to another aspect of the present disclosure may include: detecting smoke inside a battery container including one or more batteries; controlling an operating state of a ventilation unit installed in the battery container to a turned-on state when the smoke is detected; and outputting, to an external device, a ventilation operation signal indicating that the operating state of the ventilation unit has been controlled to the turned-on state.

The ventilation control method according to another aspect of the present disclosure may further include controlling the operating state of the ventilation unit to a turned-off state when a ventilation termination signal for the battery container is received from the external device after the ventilation operation signal is output to the external device.

The opening/closing unit may include a roof vent installed on a roof of the battery container and a door damper installed on a door of the battery container.

The energy storage system may further include a measurement unit that measures basic fire determination information including a temperature of the battery container and a voltage and a temperature of the one or more batteries.

The measurement unit may be configured to transmit the basic fire determination information to the second control unit, the second control unit may be configured to transmit the basic fire determination information to the first main control unit, and the first main control unit may be configured to transmit the received basic fire determination information to the second main control unit, such that the second main control unit determines the occurrence of a fire.

The ventilation control apparatus according to an embodiment of the present disclosure has an advantage in that the battery container may be rapidly ventilated by detecting smoke generated inside the battery container and operating the ventilation unit.

The effects of the present disclosure are not limited to the effects described above, and other effects not explicitly mentioned may be clearly understood by a person ordinarily skilled in the art from the description of the appended claims.

### BRIEF DESCRIPTION OF THE DRAWINGS

The following drawings attached hereto illustrate embodiments of the present disclosure and serve to further understand the technical idea of the present disclosure together with the detailed description of the disclosure to be described later. Therefore, the present disclosure should not be construed as being limited to the matters illustrated in the drawings.

FIG. 1 is a schematic view illustrating a ventilation control apparatus according to an embodiment of the present disclosure.

FIG. 2 is a schematic view illustrating a battery container according to an embodiment of the present disclosure.

FIG. 3 is a schematic view illustrating an energy storage system according to another embodiment of the present disclosure.

FIG. 4 is a schematic view illustrating a ventilation control operation of an energy storage system according to another embodiment of the present disclosure.

FIG. 5 is a schematic view illustrating a ventilation control method according to still another embodiment of the present disclosure.

Corresponding reference characters indicate corresponding components throughout the several views of the drawings. The drawing figures presented are illustrated for simplicity and clarity and have not necessarily been drawn to scale. For example, the dimensions of some elements in the figures may be exaggerated relative to other elements to improve understanding of various embodiments. Also, common but well-understood elements that are useful or necessary in a commercially feasible embodiment are often not depicted in order to facilitate a less obstructed view of these various embodiments.

### DETAILED DESCRIPTION

The terms or words used in the specification and claims should not be construed as limited to their ordinary or dictionary meanings, but should be construed as having meanings and concepts consistent with the technical concept of the present disclosure based on the principle that an inventor may appropriately define the concepts of terms in order to explain his or her own invention in the best way.

Since the embodiments described herein and the configurations illustrated in the drawings are merely examples of the present disclosure, and do not represent all of the technical spirit of the present disclosure, it should be understood that at the time of filing, there may be various equivalents and modifications that could serve as alternatives to the embodiments.

In addition, in describing the present disclosure, when it is determined that a detailed description of related well-known configurations or functions may obscure the gist of the present disclosure, such a detailed description is omitted.

Terms including ordinal numbers such as “first” and “second” are used for the purpose of distinguishing one component from another among various components, and are not used to limit the components by such terms.

Throughout the specification, when a certain part is described as “including” a certain component, this means that other components may be further included, rather than excluding other components, unless otherwise explicitly stated.

In addition, throughout the specification, when a certain part is described as being “connected” to another part, this includes a case where the parts are “directly connected,” as well as a case where the parts are “indirectly connected” with another element interposed therebetween.

Conventional energy storage systems are configured on a container-by-container basis, and a single container includes a plurality of battery racks and a power distribution panel, among other components. That is, a container having a size capable of accommodating all components of the energy storage system is required. In addition, when a plurality of energy storage systems are provided, since each energy storage system is configured as an independent container, there is a problem in that each energy storage system on a container-unit basis needs to be individually controlled.

Since batteries have the disadvantage of being vulnerable to external surges and high temperatures, an energy storage system (ESS) in which batteries are collectively stored has an inherent risk of fire. In general, a fire in an energy storage system starts at an individual battery cell level, and subsequently, the fire may propagate to a battery rack level. In this case, since a fire originating at the battery cell level may spread to the entire energy storage system, it is necessary to monitor the occurrence of a fire and to promptly take corresponding measures at the early stage of fire occurrence.

In view of the foregoing, the present disclosure provides a ventilation control method, a ventilation control apparatus, and an energy storage system including the same, which are capable of monitoring a fire within an energy storage system and extinguishing the fire at an early stage.

Hereinafter, embodiments of the present disclosure will be described with reference to the accompanying drawings.

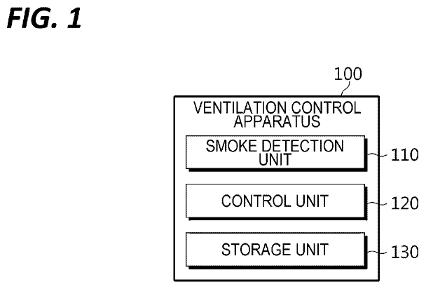

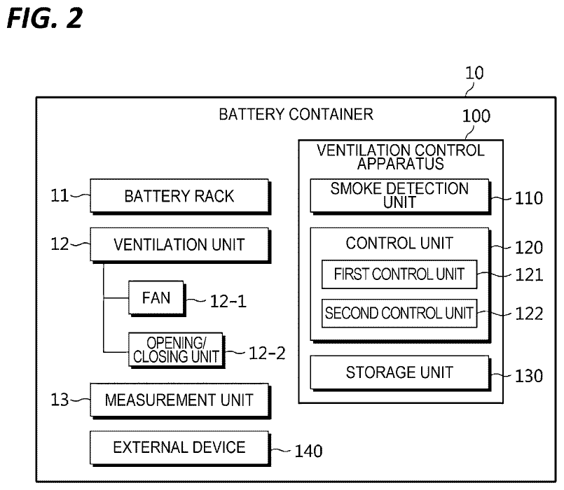

FIG. 1 is a schematic view illustrating a ventilation control apparatus 100 according to an embodiment of the present disclosure. FIG. 2 is a schematic view illustrating a battery container 10 according to an embodiment of the present disclosure.

Referring to FIG. 2, the battery container 10 may include one or more batteries, a ventilation unit 12, and a measurement unit 13.

The battery container 10 includes one or more battery racks 11, and each battery rack 11 may include one or more battery modules. Each battery module may include one or more battery cells. Here, a battery cell refers to a single independent cell that includes a negative electrode terminal and a positive electrode terminal and is physically separable. As an example, a lithium-ion battery or a lithium polymer battery may be regarded as a battery cell. In addition, the battery cell may be of a cylindrical type, a prismatic type, or a pouch type.

The measurement unit 13 may be configured to measure a temperature of the battery container 10 and a voltage and a temperature of batteries included in the battery container 10. For example, the measurement unit 13 may measure an internal temperature of the battery container 10. In addition, the measurement unit 13 may measure a voltage and a temperature of each of the battery modules included in the battery container 10. Optionally, the measurement unit 13 may measure a voltage and a temperature of each battery cell included in the battery modules. Hereinafter, for convenience of description, information regarding the temperature of the battery container 10 and the voltage and temperature of the batteries will be referred to as basic fire determination information.

The ventilation unit 12 may be configured to circulate and ventilate air inside the battery container 10. For example, the ventilation unit 12 may include a fan 12-1 configured to circulate air inside the battery container 10 and to discharge air inside the battery container 10 to the outside. In addition, the ventilation unit 12 may include an opening/closing unit 12-2 capable of ventilating the battery container 10 through opening and closing operations. For example, the opening/closing unit 12-2 may include a roof vent (roof exhaust vent) and/or a door damper (door intake damper).

Referring to FIG. 1, the ventilation control apparatus 100 may include a smoke detection unit 110 and a control unit 120.

The smoke detection unit 110 may be configured to detect smoke inside the battery container 10.

For example, the smoke detection unit 110 may include one or more smoke sensors. In addition, the smoke detection unit 110 may determine whether smoke is present inside the battery container 10.

The smoke detection unit 110 may be configured to output a sensing signal when smoke is detected.

For example, the smoke detection unit 110 may be communicatively connected to the control unit 120. The smoke detection unit 110 may output a sensing signal indicating that smoke has been detected to the control unit 120. If smoke is not detected, the smoke detection unit 110 may not output the sensing signal to the control unit 120.

The control unit 120 may be configured to control the operating state of the ventilation unit 12 installed in the battery container 10 to a turned-on state upon receiving a sensing signal.

For example, when the control unit 120 receives the sensing signal from the smoke detection unit 110, the control unit 120 may control the operating state of the ventilation unit 12 to the turned-on state so as to ventilate the battery container 10.

For example, the control unit 120 may ventilate the battery container 10 by operating the fan 12-1 and opening the opening/closing unit 12-2.

The control unit 120 may be configured to output, to an external device 140, a ventilation operation signal indicating that the operating state of the ventilation unit 12 has been controlled to the turned-on state.

For example, the control unit 120 may notify that the operating state of the ventilation unit 12 has been controlled to the turned-on state by outputting the ventilation operation signal to the external device communicatively connected thereto.

Here, the external device 140 is a device located outside the ventilation control apparatus 100 and may be included inside or outside the battery container 10. Referring to FIG. 2, according to an embodiment, the external device 140 may be included inside the battery container 10, and the external device 140 is a higher-level control device for the ventilation control apparatus 100, and may determine whether the ventilation unit 12 has been operated due to a smoke detection error of the smoke detection unit 110. The control unit 120 may request the external device 140 to determine occurrence of a fire in the battery container 10 by outputting the ventilation operation signal to the external device 140.

The ventilation control apparatus 100 according to an embodiment of the present disclosure has an advantage in that the ventilation control apparatus 100 may rapidly ventilate the battery container 10 by detecting smoke generated inside the battery container 10 and operating the ventilation unit 12.

Meanwhile, the control unit 120 provided in the ventilation control apparatus 100 may optionally include, for example, a processor known in the art, an application-specific integrated circuit (ASIC), another chipset, logic circuitry, a register, a communication modem, or a data processing device, in order to execute various control logics performed in the present disclosure. In addition, when the control logics are implemented in software, the control unit 120 may be implemented as a set of program modules. In this case, the program modules may be stored in a memory and executed by the control unit 120. The memory may be located inside or outside the control unit 120 and may be connected to the control unit 120 through various well-known means.

In addition, the ventilation control apparatus 100 may further include a storage unit 130. The storage unit 130 may store data or programs required for the respective components of the ventilation control apparatus 100 to perform operations and functions, or, for example, data generated in a process in which the operations and functions are performed. The storage unit 130 is not particularly limited in type as long as it is a known information storage medium capable of recording, erasing, updating, and reading data. As an example, the information storage medium may include, for example, RAM, flash memory, ROM, EEPROM, or a register. In addition, the storage unit 130 may store program codes in which processes executable by the respective components of the ventilation control apparatus 100 are defined.

Upon receiving a ventilation termination signal for the battery container 10 from the external device 140 after outputting the ventilation operation signal to the external device 140, the control unit 120 may be configured to control the operating state of the ventilation unit 12 to the turned-off state.

According to an embodiment, the control unit 120 may determine whether to readjust the operating state of the ventilation unit 12 based on feedback from the external device 140.

For example, when the external device 140 determines that a fire has occurred in the battery container 10, the external device 140 may not output the ventilation termination signal to the control unit 120. In this case, since the operating state of the ventilation unit 12 is maintained in the turned-on state, gas and smoke inside the battery container 10 may be discharged to the outside, and the internal temperature of the battery container 10 may be reduced. In addition, by regulating an oxygen concentration inside the battery container 10, propagation of the fire may be prevented.

As another example, when the external device 140 determines that a fire has not occurred in the battery container 10, the external device 140 may output the ventilation termination signal to the control unit 120 in order to stop the operation of the ventilation unit 12. Upon receiving the ventilation termination signal from the external device 140, the control unit 120 may control the operating state of the ventilation unit 12 to the turned-off state.

Since the smoke detection unit 110 detects smoke inside the battery container 10, the smoke detection unit 110 may detect smoke generated in a situation in which a fire has occurred, as well as smoke generated in a situation in which no fire has occurred. In addition, due to a malfunction of the smoke detection unit 110, a sensing signal indicating detection of smoke may be output to the control unit 120 even in an environment in which no smoke is present. In such a case, since the operation of the ventilation unit 12 should be stopped, the control unit 120 may re-control the operating state of the ventilation unit 12 based on a signal received from the external device 140.

If the operating state of the ventilation unit 12 is controlled to the turned-on state only after the external device 140 determines whether a fire has occurred in the battery container 10, the control unit 120 may control the operating state of the ventilation unit 12 only when receiving a separate signal from the external device 140, and thus fire suppression may not proceed promptly. In this case, although smoke is detected in a situation in which a fire has occurred, the operating state of the ventilation unit 12 may not be immediately controlled due to, for example, communication delay between the control unit 120 and the external device 140, and the fire occurring in the battery container 10 may further spread. Accordingly, it may be more effective if the ventilation unit 12 is proactively operated first, and thereafter the external device 140 determines a fire situation and transmits a ventilation termination signal when necessary.

In addition, even when the operating state of the ventilation unit 12 is controlled to the turned-on state due to, for example, a malfunction of the smoke detection unit 110, no damage is caused to the battery container 10 by operation of the ventilation unit 12. Based on this stability, the present disclosure may operate the ventilation unit 12 in a fire-suspected situation without concern for malfunction. In addition, the present disclosure provides an effect of securing a response time capable of preventing fire propagation by eliminating operational delay caused by communication delay or waiting for determination when a fire occurs.

Accordingly, the ventilation control apparatus 100 according to an embodiment of the present disclosure has an advantage in that the ventilation control apparatus 100 may rapidly respond to a fire by preferentially controlling the operating state of the ventilation unit 12 based on a sensing signal of the smoke detection unit 110. In addition, the ventilation control apparatus 100 has an advantage in that the ventilation control apparatus 100 may correct a malfunction of the ventilation unit 12 by re-controlling the operating state of the ventilation unit 12 based on a signal from the external device 140.

Hereinafter, an embodiment of the control unit 120 will be described.

Referring to FIG. 2, the control unit 120 may include a first control unit 121 and a second control unit 122.

The first control unit 121 may be configured to output a ventilation operation signal to the second control unit 122 and the external device 140 upon receiving a sensing signal from the smoke detection unit 110.

For example, the first control unit 121 may be communicatively connected to the smoke detection unit 110, the second control unit 122, and the external device 140. In addition, when the first control unit 121 receives the sensing signal from the smoke detection unit 110, the first control unit 121 may output the ventilation operation signal to the second control unit 122 and the external device 140.

For example, the first control unit 121 may be a fire alarm control panel (FACP).

Upon receiving the ventilation operation signal from the first control unit 121, the second control unit 122 may be configured to control the operating state of the ventilation unit 12 to a turned-on state.

According to an embodiment, the second control unit 122 may be configured to control the operating state of the ventilation unit 12. For example, the second control unit 122 may control the operating state of the fan 12-1 included in the ventilation unit 12 to the turned-on state. In addition, the second control unit 122 may control the operating state of the opening/closing unit 12-2 included in the ventilation unit 12 to an open state (turned-on state).

The first control unit 121 and the second control unit 122 are included in the ventilation control apparatus 100, and the second control unit 122 may be configured to receive the ventilation operation signal prior to the external device 140. Accordingly, the operating state of the ventilation unit 12 may be controlled to the turned-on state before the first control unit 121 receives a ventilation termination signal from the external device 140.

For example, when the battery container 10 is referred to as an M-LINK, the second control unit 122 may be an M-programmable logic controller (PLC) included in the battery container 10. The second control unit 122 may be connected to components included in the battery container 10, such as a heating, ventilation, and air conditioning (HVAC) system, an uninterruptible power supply unit, a door sensor, a switch, a switching mode power supply (SMPS), a fire suppression system (FSS), the smoke detection unit 110, and the ventilation unit 12, and may control these components.

Upon determining that a fire has not occurred in the battery container 10, the external device 140 may output a first ventilation termination signal to the first control unit 121 and may output a second ventilation termination signal to the second control unit 122. Here, the first ventilation termination signal is a signal for notifying the first control unit 121 of cancellation of ventilation diagnosis, and the second ventilation termination signal is a signal for controlling the operating state of the ventilation unit 12 to a turned-off state. According to an embodiment, the first ventilation termination signal and the second ventilation termination signal may be implemented as the same signal or as different signals.

In an embodiment, the first control unit 121 and the second control unit 122 may control operating states of different devices of the ventilation unit 12.

For example, upon receiving a first ventilation termination signal from the external device 140, the first control unit 121 may be configured to control the operating state of the fan 12-1 included in the ventilation unit 12 to a turned-off state. In addition, upon receiving a second ventilation termination signal from the external device 140, the second control unit 122 may be configured to control the operating state of the opening/closing unit 12-2 included in the ventilation unit 12 to a closed state.

In another embodiment, in order to stop the operation of the ventilation unit 12 more rapidly, the first control unit 121 may directly control the operating state of the ventilation unit 12 to the turned-off state.

For example, the first control unit 121 may control the operating states of both the fan 12-1 and the opening/closing unit 12-2 included in the ventilation unit 12 to the turned-off state. The first control unit 121 may be configured to control the operating state of the ventilation unit 12 to the turned-off state by controlling the operating state of a relay electrically connected to the ventilation unit 12 to the turned-off state.

The ventilation control apparatus 100 according to an embodiment of the present disclosure is capable of independently performing operations by the first control unit 121 and the second control unit 122. Accordingly, even when a problem occurs in one control unit (e.g., the first control unit 121), the remaining control unit (e.g., the second control unit 122) may perform a control function to maintain normal operation without interruption of the system. Therefore, the system safety of the ventilation control apparatus 100 may be increased as compared with a case where a single control unit 120 is used. In addition, since respective control units 121 and 122 are designed as independent modules, maintenance and replacement may be facilitated. Further, according to an embodiment, the first control unit 121 may be optimized for communication processing with the smoke detection unit 110, the second control unit 122, and the external device 140, and the second control unit 122 may be optimized for control of the operating state of the ventilation unit 12, whereby functions of the respective control units 121 and 122 may be implemented in a more detailed and specialized manner.

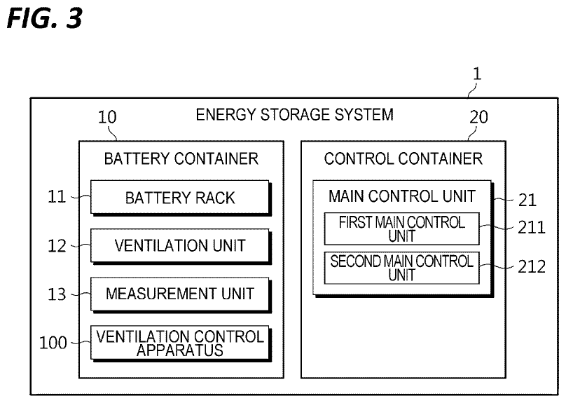

FIG. 3 is a schematic view illustrating an energy storage system 1 according to another embodiment of the present disclosure.

Referring to FIG. 3, the energy storage system 1 may include a battery container 10 and a control container 20. The ventilation control apparatus 100 may include, according to the embodiment illustrated in FIG. 2, a smoke detection unit 110, a control unit 120 including a first control unit 121 and a second control unit 122, a storage unit 130, among other components. Here, the battery container 10 may be referred to as an M-LINK or a B-LINK including one or more batteries, and the control container 20 may be referred to as an E-LINK.

The control container 20 may include a main control unit 21 configured to determine occurrence of a fire in the battery container 10 upon receiving a ventilation operation signal from the control unit 120.

For example, the main control unit 21 may be configured to determine occurrence of a fire based on at least one of a temperature of the battery container 10, a voltage of one or more batteries, and a temperature of one or more batteries, which are measured for a predetermined period of time from a time point at which the ventilation operation signal is received.

Here, since the main control unit 21 is included in the control container 20, the main control unit 21 may receive basic fire determination information from the control unit 120.

The second control unit 122 may receive basic fire determination information from the measurement unit 13. In addition, the main control unit 21 may receive the basic fire determination information from the second control unit 122.

For example, the main control unit 21 may determine that a fire has occurred in the battery container 10 when at least one of a case where a temperature of the battery container 10 is equal to or greater than a first threshold temperature, a case where a temperature of at least one battery is equal to or greater than a second threshold temperature, and a case where a voltage of at least one battery is equal to or greater than a threshold voltage continues for a predetermined period of time. For example, the predetermined period of time may be preset to 30 seconds.

However, since the main control unit 21 may determine occurrence of a fire in the battery container 10 in various manners based on the basic fire determination information, it should be noted that the method by which the main control unit 21 determines occurrence of a fire is not particularly limited to the embodiments described above.

First, when the main control unit 21 determines that a fire has occurred in the battery container 10, since the operating state of the ventilation unit 12 has already been controlled to a turned-on state, the main control unit 21 may not output a separate ventilation termination signal to the first control unit 121 and the second control unit 122.

In the meantime, when the main control unit 21 determines that a fire has not occurred in the battery container 10, since the ventilation unit 12 is operating unnecessarily, the main control unit 21 may output a ventilation termination signal to the first control unit 121 and the second control unit 122.

An energy storage system 1 according to another embodiment of the present disclosure may rapidly suppress a fire by operating a ventilation unit 12 when smoke is detected, even before occurrence of a fire is determined. In addition, when a fire has not occurred, operation of the ventilation unit 12 may be stopped to prevent or suppress unnecessary operation of the ventilation unit 12.

Meanwhile, the main control unit 21 provided in the energy storage system 1 may optionally include, for example, a processor known in the art, an application-specific integrated circuit (ASIC), another chipset, logic circuitry, a register, a communication modem, or a data processing device, in order to execute various control logics performed in the present disclosure. In addition, when the control logics are implemented in software, the main control unit 21 may be implemented as a set of program modules. In this case, the program modules may be stored in a memory and executed by the main control unit 21. The memory may be located inside or outside the main control unit 21 and may be connected to the main control unit 21 through various well-known means.

Hereinafter, an embodiment of the main control unit 21 will be described.

The main control unit 21 may include a first main control unit 211 and a second main control unit 212.

The first main control unit 211 may be configured to receive a ventilation operation signal from the control unit 120. In addition, the first main control unit 211 may transmit the received ventilation operation signal to the second main control unit 212.

The first main control unit 211 may be communicatively connected to the first control unit 121, the second control unit 122, and the second main control unit 212. The main control unit 21 communicatively connected to the ventilation control apparatus 100 is the first main control unit 211.

For example, when the control container 20 is referred to as an E-LINK, the first main control unit 211 may be an E-PLC. The first main control unit 211 may be connected to components included in the control container 20, such as an HVAC system, an uninterruptible power supply unit, a door sensor, a fuse, a switch, an SMPS, an FSS, a surge protection unit, and an insulation measurement unit 13, and may control these components.

Upon receiving the ventilation operation signal from the first main control unit 211, the second main control unit 212 may be configured to determine occurrence of a fire.

The second main control unit 212 may receive basic fire determination information from the second control unit 122 via the first main control unit 211. For example, the measurement unit 13 may transmit the basic fire determination information to the second control unit 122, the second control unit 122 may transmit the basic fire determination information to the first main control unit 211, and the first main control unit 211 may transmit the basic fire determination information to the second main control unit 212. The basic fire determination information output from the measurement unit 13 may reach the second main control unit 212 via the second control unit 122 and the first main control unit 211.

For example, the second main control unit 212 may be a battery system control unit (BSC) and may be a highest-level control unit included in the energy storage system 1. The second main control unit 212 may receive signals related to internal operations of both the control container 20 and the battery container 10.

Upon determining that a fire has not occurred in the battery container 10, the second main control unit 212 may be configured to output a fire non-occurrence signal to the first main control unit 211. In addition, upon receiving the fire non-occurrence signal from the second main control unit 212, the first main control unit 211 may be configured to output a ventilation termination signal to the control unit 120. Upon receiving the ventilation termination signal from the second main control unit 212, the control unit 120 may control the operating state of the ventilation unit 12 to a turned-off state.

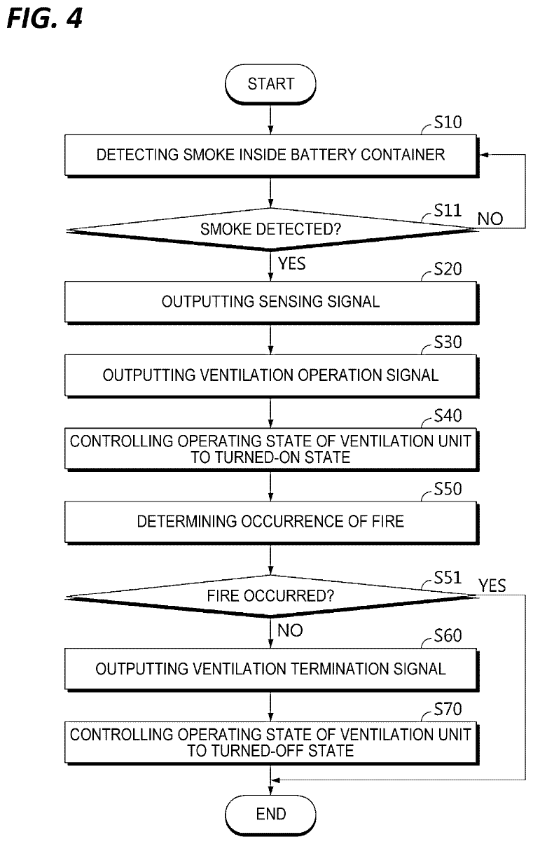

FIG. 4 is a schematic view illustrating a ventilation control operation of an energy storage system 1 according to another embodiment of the present disclosure.

In step S10, the smoke detection unit 110 may operate to detect smoke inside the battery container 10. For example, the smoke detection unit 110 may detect smoke at predetermined intervals.

In step S11, when the smoke detection unit 110 detects smoke inside the battery container 10 (YES), step S20 is performed, and when smoke is not detected (NO), step S10 may be performed.

In step S20, the smoke detection unit 110 may output a sensing signal indicating that smoke has been detected inside the battery container 10 to the first control unit 121.

In step S30, the first control unit 121 may output a ventilation operation signal to the second control unit 122 and the first main control unit 211.

In step S40, upon receiving the ventilation operation signal, the second control unit 122 may control the operating state of the ventilation unit 12 to a turned-on state. For example, operating states of both the fan 12-1 and the opening/closing unit 12-2 may be controlled to the turned-on state by the second control unit 122.

In step S50, the first main control unit 211 may transmit the ventilation operation signal to the second main control unit 212. In addition, the second main control unit 212 may determine occurrence of a fire in the battery container 10 based on basic fire determination information for a predetermined period of time from a time point at which the ventilation operation signal is received.

Here, since the first control unit 121 and the second control unit 122 are configured to perform communication with higher priority than the first control unit 121 and the first main control unit 211, the ventilation unit 12 may be operated from a time point prior to a time point at which the second main control unit 212 determines occurrence of a fire. In addition, the ventilation unit 12 may continue to be operated while the second main control unit 212 determines occurrence of a fire.

In step S51, when it is determined that a fire has not occurred in the battery container 10 (NO), step S60 is performed, and otherwise (YES), the ventilation control operation may be terminated.

In step S60, when it is determined that a fire has not occurred in the battery container 10, the second main control unit 212 may output a ventilation termination signal to the first main control unit 211. In addition, the first main control unit 211 may output the ventilation termination signal to the first control unit 121 and the second control unit 122. For example, the first main control unit 211 may output a first ventilation termination signal to the first control unit 121 and may output a second ventilation termination signal to the second control unit 122.

In an embodiment, in step S70, upon receiving the ventilation termination signal, the first control unit 121 and the second control unit 122 may control an operating state of the ventilation unit 12 to a turned-off state. For example, the first control unit 121 may control the operating state of the fan 12-1 included in the ventilation unit 12 to a turned-off state, and the second control unit 122 may control the operating state of the opening/closing unit 12-2 included in the ventilation unit 12 to a closed state.

In another embodiment, in step S70, in order to rapidly stop the operation of the ventilation unit 12, upon receiving the ventilation termination signal, the first control unit 121 may control the operating states of both the fan 12-1 and the opening/closing unit 12-2 of the ventilation unit 12 to turned-off states.

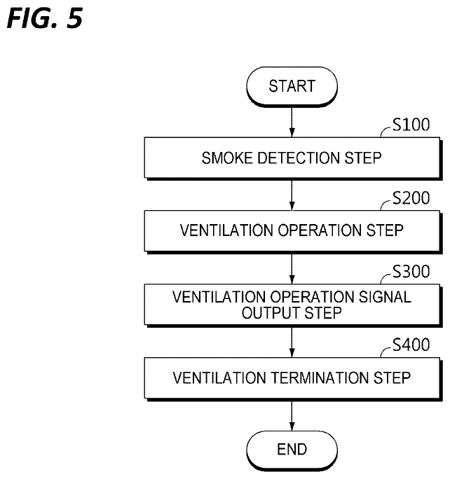

FIG. 5 is a schematic view illustrating a ventilation control method according to still another embodiment of the present disclosure.

Referring to FIG. 5, the ventilation control method may include a smoke detection step (S100), a ventilation operation step (S200), and a ventilation operation signal output step (S300).

Each step of the ventilation control method may be performed by the ventilation control apparatus 100. Hereinafter, for convenience of description, descriptions that overlap with those described above will be omitted or briefly described.

The smoke detection step (S100) is a step of detecting smoke inside the battery container 10 including one or more batteries, and may be performed by the smoke detection unit 110.

For example, the smoke detection unit 110 may include one or more smoke sensors and may detect smoke inside the battery container 10.

The ventilation operation step (S200) is a step of controlling the operating state of the ventilation unit 12 installed in the battery container 10 to a turned-on state when smoke is detected, and may be performed by the control unit 120.

For example, when the control unit 120 receives a sensing signal from the smoke detection unit 110, the control unit 120 may control the operating state of the ventilation unit 12 to the turned-on state so as to ventilate the battery container 10.

The ventilation operation signal output step (S300) is a step of outputting, to an external device 140, a ventilation operation signal indicating that the operating state of the ventilation unit 12 has been controlled to the turned-on state, and may be performed by the control unit 120.

The control unit 120 may notify the external device 140, which is communicably connected thereto, that the operating state of the ventilation unit 12 has been controlled to the turned-on state by outputting the ventilation operation signal to the external device 140.

Referring further to FIG. 5, the ventilation control method may further include a ventilation termination step (S400).

The ventilation termination step (S400) is a step of controlling the operating state of the ventilation unit 12 to a turned-off state when a ventilation termination signal for the battery container 10 is received from the external device 140 after the ventilation operation signal is output to the external device 140, and may be performed by the control unit 120.

For example, when the external device 140 determines that a fire has occurred in the battery container 10, the external device 140 may not output the ventilation termination signal to the control unit 120. In this case, since the operating state of the ventilation unit 12 is maintained in the turned-on state, gas and smoke inside the battery container 10 may be discharged to the outside, and the internal temperature of the battery container 10 may be reduced. In addition, by regulating an oxygen concentration inside the battery container 10, propagation of the fire may be prevented or suppressed.

As another example, when the external device 140 determines that a fire has not occurred in the battery container 10, the external device 140 may output the ventilation termination signal to the control unit 120 in order to stop the operation of the ventilation unit 12. Upon receiving the ventilation termination signal from the external device 140, the control unit 120 may control the operating state of the ventilation unit 12 to the turned-off state.

The embodiments of the present disclosure described above may be implemented through an apparatus and a method, as well as through a program that realizes functions corresponding to the configurations of the embodiments of the present disclosure, or a recording medium in which the program is recorded. Such implementations may be readily achieved by a person ordinarily skilled in the art to which the present disclosure pertains, based on the descriptions of the embodiments set forth above.

Although the present disclosure has been described above with reference to limited embodiments and drawings, the present disclosure is not limited thereto, and various modifications and variations may be made by a person ordinarily skilled in the art to which the present disclosure pertains within the technical spirit of the present disclosure and the equivalent scope of the claims set forth below.

While the technology of the present disclosure has been described with reference to embodiments, it may be appreciated by one skilled in the art of the present disclosure or one having ordinary skill in the art of the present disclosure that various modifications and changes may be made to the various embodiments of the present disclosure without departing from the technical scope of the various embodiments of the present disclosure defined in the claims attached herewith.

### DESCRIPTION OF SYMBOLS

1 Energy storage system
10 Battery container
11 Battery rack
12 Ventilation unit
13 Measurement unit
20 Control container
21 Main control unit
211 First main control unit
212 Second main control unit
100 Ventilation control apparatus
110 Smoke detection unit
120 Control unit
121 First control unit
122 Second control unit
130 Storage unit

What is claimed is:

1. A ventilation control apparatus that is installed in a battery container including one or more batteries, the apparatus comprising:
a smoke detector configured to detect smoke inside the battery container and to output a sensing signal when the smoke is detected; and
a controller configured to, upon receiving the sensing signal, control an operating state of a ventilation unit installed in the battery container to a turned-on state, and to output, to an external device, a ventilation operation signal indicating that the operating state of the ventilation unit has been controlled to the turned-on state.

2. The ventilation control apparatus according to claim 1, wherein the controller is further configured to control the operating state of the ventilation unit to a turned-off state upon receiving a ventilation termination signal for the battery container from the external device after outputting the ventilation operation signal to the external device.

3. The ventilation control apparatus according to claim 1, wherein the controller includes:
a first controller configured to, upon receiving the sensing signal from the smoke detector, output the ventilation operation signal to a second controller and the external device; and
the second controller configured to, upon receiving the ventilation operation signal from the first controller, control the operating state of the ventilation unit to the turned-on state.

4. The ventilation control apparatus according to claim 3, wherein the first controller is configured to control an operating state of a fan included in the ventilation unit to a turned-off state upon receiving a first ventilation termination signal from the external device,
the second controller is configured to control an operating state of an opening/closing unit included in the ventilation unit to a closed state upon receiving a second ventilation termination signal from the external device.

5. The ventilation control apparatus according to claim 3, wherein the first controller is configured to control the operating state of the ventilation unit to a turned-off state upon receiving the first ventilation termination signal from the external device.

6. The ventilation control apparatus according to claim 5, wherein the first controller is configured to control the operating state of the ventilation unit to the turned-off state by controlling an operating state of a relay electrically connected to the ventilation unit to the turned-off state.

7. An energy storage system comprising:
the battery container including the ventilation control apparatus according to claim 1; and
a control container,
wherein the control container includes a main controller configured to determine occurrence of a fire in the battery container upon receiving the ventilation operation signal from the controller.

8. The energy storage system according to claim 7, wherein the main controller is configured to determine the occurrence of a fire based on at least one of a temperature of the battery container, a voltage of the one or more batteries, and a temperature of the one or more batteries, which are measured for a predetermined period of time from a time point at which the ventilation operation signal is received.

9. The energy storage system according to claim 7, wherein the main controller includes:
a first main controller configured to receive the ventilation operation signal from the controller; and
a second main controller configured to determine the occurrence of a fire upon receiving the ventilation operation signal from the first main controller.

10. The energy storage system according to claim 9, wherein
the second main controller is configured to output a fire non-occurrence signal to the first main controller upon determining that a fire has not occurred in the battery container, and
the first main controller is configured to output a ventilation termination signal to the controller upon receiving the fire non-occurrence signal from the second main controller.

11. A ventilation control method comprising:
a smoke detection step of detecting smoke inside a battery container including one or more batteries;
a ventilation operation step of controlling an operating state of a ventilation unit installed in the battery container to a turned-on state when the smoke is detected; and
a ventilation operation signal output step of outputting, to an external device, a ventilation operation signal indicating that the operating state of the ventilation unit has been controlled to the turned-on state.

12. The ventilation control method according to claim 11, further comprising:
a ventilation termination step of controlling the operating state of the ventilation unit to a turned-off state when a ventilation termination signal for the battery container is received from the external device after the ventilation operation signal is output to the external device.

13. The ventilation control apparatus according to claim 4, wherein the opening/closing unit includes a roof vent installed on a roof of the battery container and a door damper installed on a door of the battery container.

14. The energy storage system according to claim 9, further comprising:
a measurement unit configured to measure basic fire determination information including a temperature of the battery container and a voltage and a temperature of the one or more batteries,
wherein the measurement unit is configured to transmit the basic fire determination information to the second controller, the second controller is configured to transmit the basic fire determination information to the first main controller, and the first main controller is configured to transmit the received basic fire determination information to the second main controller, such that the second main controller determines the occurrence of a fire.
